(19) United States
(12) Patent Application Publication
(10) Pub. No.: US 2025/0247377 A1
(43) Pub. Date: Jul. 31, 2025

(54) MAINTAINING SECURITY OF COMMUNICATIONS IN A MULTI-DEVICE ENVIRONMENT

(71) Applicant: Google LLC, Mountain View, CA (US)

(72) Inventors: Marcel M.M. Yung, New York, NY (US); Omer Berkman, Tel Aviv (IL)

(21) Appl. No.: 19/035,616

(22) Filed: Jan. 23, 2025

Related U.S. Application Data
(60) Provisional application No. 63/625,225, filed on Jan. 25, 2024.

(51) Int. Cl. H04L 9/40; H04L 9/08; H04L 9/14

(52) U.S. Cl. CPC H04L 63/0435; H04L 9/0869; H04L 9/14

(57) ABSTRACT

Methods and systems for maintaining security of communications in a multi-device environment are provided herein. A private key associated with a first device is obtained. The private key is known to the first device and unknown to other devices. A public key is generated based on the obtained private key. The public key and the symmetric key is provided to a second device. A respective ephemeral key is generated for each time period of a future time window, where each ephemeral key is generated based on the private key and the symmetric key. A set of hash values is obtained based on each respective ephemeral key and provided to a computing device of a platform. A notification of a secure message of the second device for the first device is received. Content of the secure message is accessed based on the symmetric key and the private key.

### RELATED APPLICATIONS

The present application claims the benefit under 35 U.S.C. § 119(e) of U.S. Provisional Patent Application No. 63/625,225, entitled “Maintaining Security of Communications in a Multi-Device Environment,” and filed Jan. 25, 2024, which is incorporated by reference herein.

### TECHNICAL FIELD

Aspects and implementations of the present disclosure relate to maintaining security of communications in a multi-device environment.

### BACKGROUND

A beacon device refers to a small, wireless transmitter that emits signals that are detectable by nearby client devices (e.g., smartphones, tablets, etc.). In an Internet of Things (IoT) ecosystem, beacon devices (simply referred to herein as “beacons”) can serve as nodes that facilitate interaction between physical objects and digital environments. For example, a user can attach a beacon to a real-world object that does not include a wireless transmitter or other such digital communication element (e.g., keys, a wallet, a bicycle, etc.) and can track a location or other data pertaining to the real-world object, e.g., based on signals transmitted by the beacon to and received by a client device of the user. It is a challenge to maintain security of signals transmitted to and from a beacon, which is in part due to limited computing resources (e.g., memory resources, networking bandwidth resources, etc.) available to the beacon.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a method is disclosed for obtaining, by a first device, a private key associated with the first device. The private key is known to the first device and unknown to other devices. The method further includes generating, by the first device, a public key based on the obtained private key. The method further includes providing, by the first device, the public key and a symmetric key to a second device. The method further includes generating, by the first device, a respective ephemeral key for each time period of a future time window. Each respective ephemeral key is generated based on the private key and the symmetric key. The method further includes obtaining, by the first device, a set of hash values based on each respective ephemeral key. The method further includes providing, by the first device, the obtained set of hash values to a computing device of a platform. The method further includes receiving, by the first device, a notification of a secure message of the second device for the first device. The secure message is encoded based on a hash value of the set of hash values corresponding to a current time period of the future time window. The method further includes accessing, by the first device, content of the secure message based on the symmetric key and the private key.

In some implementations, the method further includes generating, by the first device, a respective ephemeral key for each time period of a future time window. Each respective ephemeral key is generated based on the private key and the symmetric key. The method further includes obtaining a set of hash values based on each respective ephemeral key. The method further includes providing the obtained set of hash values to a computing device of a platform.

In some implementations, accessing the content of the secure message based on the symmetric key and the private key includes determining a time period when the notification of the secure message is received, generating a private ephemeral key for the time period based on the symmetric key and the private key, and initiating a decryption operation to decrypt the content of the secure message using the private ephemeral key.

In some implementations, the method further includes responsive to determining that the decryption operation cannot be completed using the private ephemeral key, generating an additional private ephemeral key for a prior time period to the time period when the notification of the secure message is received, and initiating the decryption operation to decrypt the content of the secure message using the additional private ephemeral key.

In some implementations, the first device is a client device and the second device is a beacon device.

In some implementations, the contents of the secure message indicates a geographic region of the second device.

In some implementations, the contents of the secure message indicates a set of geographic coordinates of a third device located within the indicated geographic region during a time period when the third device detected a signal emitted by the second device.

In some implementations, the notification of the secure message is received from a computing device of a platform, the computing device including at least one of a server machine of the platform or the third device.

In some implementations, obtaining the private key includes extracting a random value from one or more outputs of a random value generator.

In some implementations, a system including a memory and a set of one or more processing devices coupled to the memory is disclosed. The set of one or more processing devices is to perform operations including receiving a public key and a symmetric key from a device. The public key is generated based on a private key that is known to the device and unknown to other devices. The operations further include generating a public ephemeral key for a first time period based on the public key and the symmetric key. The operations further include broadcasting a signal comprising the generated public ephemeral key for the first time period.

In some implementations, the operations further include upon detecting that the first time period has expired, generating an updated public ephemeral key for a second time period based on the public key and the symmetric key, and broadcasting an additional signal comprising the updated public ephemeral key.

In some implementations, generating the public ephemeral key for the first time period includes providing the public key, the symmetric key, and an indication of the first time period as an input to a cryptographic function, obtaining one or more outputs of the cryptographic function, and extracting the public ephemeral key from the obtained one or more outputs of the cryptographic function.

In some implementations, the cryptographic function is an asymmetric key generation function.

In some implementations, the system is included in a beacon device, and the device is a client device associated with a user of a platform.

In some implementations, the system further includes one or more sensors configured to collect data pertaining to an environment of the system. In some implementations, the broadcast signal further includes the data collected by the one or more sensors during the first time period.

### BRIEF DESCRIPTION OF DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram that includes an example platform and an example device management engine, in accordance with implementations of the present disclosure.

FIG. 3 depicts an example of a security scheme for a multi-device environment, in accordance with implementations of the present disclosure.

FIG. 4 depicts a flow diagram of an example method for maintaining security of communications in a multi-device environment, in accordance with implementations of the present disclosure.

FIG. 5 depicts a flow diagram of an example method for maintaining security of communications in a multi-device environment, in accordance with implementations of the present disclosure.

FIG. 6 illustrates an example predictive system, in accordance with implementations of the present disclosure.

FIG. 7 is a block diagram illustrating an exemplary computer system, in accordance with implementations of the present disclosure.

### DETAILED DESCRIPTION

Aspects of the present disclosure relate to maintaining security of communications in a multi-device environment. A beacon device (simply referred to herein as a “beacon”) refers to a wireless transmitter that emits signals detectable by nearby devices (e.g., client devices, such as smartphones, tablets, etc.). In some instances, a beacon can communicate with other devices via low energy wireless technology (e.g., Bluetooth® Low Energy (BLE) technology, near field communication (NFC) technology, etc.). A user may attach a beacon to a real-world object that is otherwise not capable of communication with a digital environment (e.g., keys, a wallet, a bicycle, etc.) and can track data pertaining to the real-world object based on signals transmitted by the beacon. In an illustrative example, a user can attach a beacon to their wallet and can track a location of the wallet based on the signals transmitted by the beacon and received by the user's client device (e.g., the user's smartphone, etc.). For purposes of example and illustration only, a client device associated with a beacon is referred to as an “owner device.”

In some instances, an owner device and a beacon can share a symmetric cryptographic key (referred to herein as a “symmetric key”) for encrypting and/or decrypting communications between the owner device and the beacon. In some instances, a beacon may be located outside of a communication range from the owner device (e.g., located at a distance that is too far away from the owner device to communicate via the low energy wireless connection). The beacon may generate a public ephemeral cryptographic key (referred to herein as a “public ephemeral key”) based on the symmetric key and broadcast a signal including the public ephemeral key that is detectable to devices within the communication range. An ephemeral key refers to a cryptographic key that is usable for a particular time period (e.g., in accordance with a security protocol of a system). In accordance with the previous illustrative example, the wallet with the attached beacon may be outside of the range of communication from the owner device. The beacon may broadcast a signal including the public ephemeral key for detection by devices within the communication range. A client device (e.g., another user's smartphone, etc.) in the communication range can detect the broadcast signal and can generate and/or forward a message of the beacon to the owner device. The message can be sent from the beacon and/or generated by the gateway based on the signal detected by the gateway. Such client device can therefore serve as a gateway of communication between the beacon and the owner device (e.g., via wi-fi network, a cellular network, etc.), and is referred to herein as a “gateway device” or simply a “gateway.” The gateway can encrypt the message using the public ephemeral key of the broadcast signal and can forward the encrypted message to the owner device. Upon receiving the encrypted message, the owner device can generate the public ephemeral key based on the symmetric key and use the public ephemeral key to decrypt the message and access the message contents. In some examples, contents of the message can indicate a location of the gateway at the time the broadcast signal from the beacon was detected, which can therefore indicate the location (or approximate location) of the beacon and the wallet.

As indicated above, signals broadcast by the beacon can be detected by client devices within the range of communication of the beacon. Unfortunately, some client devices can be associated with malicious actors, who may gain physical access to the beacon. A malicious actor that gains physical access to the beacon (e.g., by finding the wallet attached to the beacon) may read secret data of the beacon's memory, which can include the symmetric key shared between the owner device and the beacon. Upon accessing the symmetric key, the malicious actor may decrypt prior encrypted messages between the owner device and the beacon and/or future encrypted messages between the owner device and the beacon using the symmetric key. Accordingly, the privacy and security of communications between the owner device and beacon are compromised and data associated with the owner device and/or beacon is vulnerable. In some instances, the owner device and/or a platform associated with the beacon may detect the security breach and the owner device may issue a new symmetric key to the beacon for encrypting future messages. It can take a significant amount of computing resources (e.g., processing cycles, memory resources, network bandwidth, etc.) to detect a security breach and generate and distribute a new key. Such resources are therefore unavailable to other processes, which can reduce an overall efficiency and increase an overall latency of the system. In addition, the owner device is able to provide the beacon with the new key when the beacon is within a communication range of the beacon (e.g., as supported by the low energy wireless technology). Accordingly, if the beacon is located outside of the communication range from the owner device when the malicious actor gains physical access to the beacon, the owner device may be unable to provide the beacon with the new key and messages between the owner device and the beacon may be vulnerable. Further, while the new symmetric key may be used to prevent the malicious actor from accessing future messages, prior and/or future messages encrypted using the exposed symmetric key are still vulnerable, and thus conventional techniques do not ensure backward security in a multi-device environment.

Embodiments of the present disclosure address the above and other deficiencies by providing techniques for maintaining security of communications in a multi-device environment. During initialization of a connection between an owner device and a beacon device, the owner device can obtain a private cryptographic key (referred to herein as a “private key”) that is known only to the owner device. The owner device can generate a public cryptographic key (referred to herein as a “public key”) based on the private key, where the private key cannot be determined or calculated from the public key. The owner device can also generate a symmetric key and can provide the public key and the symmetric key to the beacon.

Upon receiving the public key and the symmetric key from the owner device, the beacon generates one or more public ephemeral keys based on the public key and the symmetric key. In an illustrative example, the beacon can generate a first public ephemeral key for a first time period based on the public key and the symmetric key received from the owner device. The beacon can broadcast a signal including the first public ephemeral key during the first time period. Upon detecting that the first time period has expired (or is soon to expire), the beacon can generate a second public ephemeral key for a second time period based on the public key and the symmetric key, and can broadcast the signal including the second public ephemeral key during the second time period.

A client device within the range of communication to the beacon can detect the broadcast signal and act as a gateway to generate and/or forward a message from the beacon to the owner device. The gateway can encrypt the message using the public ephemeral key included in the broadcast signal and can transmit the encrypted message to the owner device and/or to a computing device of a platform associated with the beacon device. Further details regarding the gateway and the generation and transmission of messages to the owner device are provided herein.

The owner device can receive notice (e.g., from the gateway or from the computing device of the platform) of a secure message of the beacon. In some embodiments, the owner device can generate a private ephemeral key for the time period when the notice was received and/or the beacon transmitted the signal based on the symmetric key and the private key. The private ephemeral key can be the same or similar to the public ephemeral key generated by the beacon. The owner device can decrypt the secure message using the private ephemeral key to access the content of the message. In an illustrative example, the content of the message can indicate a location of the gateway during the time period when the broadcast signal was detected, which therefore can indicate the location (or approximate location) of the beacon.

Aspects and embodiments of the present disclosure enable backward and forward security of messages between two or more devices in an environment based on a private key that is known only to a single device in the environment. As indicated above, the private key obtained by the owner device is known only to the owner device and is unknown to other devices in the environment, including the beacon. Further, the public key that is generated based on the private key cannot be used to determine the private key and the beacon generates the public ephemeral key based on the public key, without the beacon having access to the private key of the owner device. Accordingly, even if a malicious actor gains physical access to the beacon device and accesses the public key and the symmetric key from the beacon memory, the malicious actor will not be able to decrypt prior or future messages between the owner device and the beacon, as the malicious actor cannot determine the value of the private key. Further, according to embodiments of the present disclosure, the identity and/or data associated with the owner device cannot be determined based on the public key and/or the symmetric key. Accordingly, the privacy and security of the owner's identity and/or data is maintained, even if the malicious actor gains physical access to the beacon device.

For at least the reasons stated above, embodiments of the present disclosure enable backward security (e.g., security of future messages) and forward security (e.g., security of prior messages) for the owner device and the beacon, thus ensuring the security and privacy of data associated with the owner device and/or the beacon. As the security and privacy of the owner device and/or beacon data is maintained, the computing resources (e.g., processing cycles, memory space, network bandwidth, etc.) are not consumed to detect such security breaches by malicious actors and to generate new cryptographic keys. Such computing resources are therefore available to other processes of the system, which increases the overall efficiency and decreases the overall latency of the system. Further, a size of the public key and a size of the subsequent public ephemeral key generated according to embodiments of the present disclosure satisfy memory and bandwidth constraints associated with the beacon, therefore enabling backward and forward security within the constraints associated with the beacon.

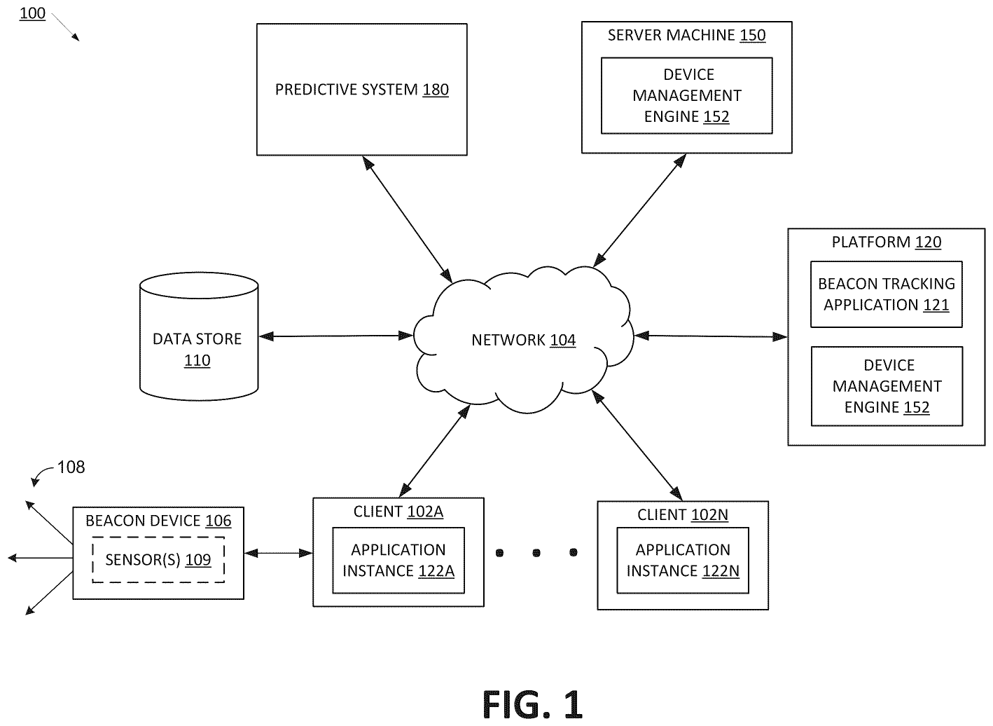

FIG. 1 illustrates an example system architecture 100, in accordance with implementations of the present disclosure. The system architecture 100 (also referred to as “system” herein) includes client devices 102A-N (collectively and individually referred to as client device 102 herein), a data store 110, a platform 120, server machine 150, and/or a predictive system 180 each connected to a network 104. In some embodiments, system 100 can include one or more beacon devices 106 (also referred to herein as “beacons”), which are associated with client devices 102, as described herein. In implementations, network 104 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. In some embodiments, system 100 can be or otherwise include a cloud-based computing environment (also referred to as a “cloud-based environment” herein).

In some implementations, data store 110 is a persistent storage that is capable of storing data as well as data structures to tag, organize, and index the data. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 104.

The client devices 102A-N (collectively and individually referred to as client device(s) 102 or client device 102 herein) may each include computing devices such as personal computers (PCs), laptops, mobile phones, smart phones, tablet computers, netbook computers, network-connected televisions, etc. In some implementations, client devices 102A-N may also be referred to as “user devices.” Each client device may include a content viewer. In some implementations, a content viewer may be an application that provides a user interface (UI) for users to view or otherwise access data or content, such as images, video items, web pages, documents, etc. For example, the content viewer may be a web browser that can access, retrieve, present, and/or navigate content (e.g., web pages such as Hyper Text Markup Language (HTML) pages, digital media items, etc.) served by a web server. The content viewer may render, display, and/or present the content to a user. The content viewer may also include an embedded media player (e.g., a Flash® player or an HTML5 player) that is embedded in a web page (e.g., a web page that may provide information about a product sold by an online merchant). In another example, the content viewer may be a standalone application (e.g., a mobile application or app) that allows users to view digital media items (e.g., digital video items, digital images, electronic books, etc.).

As indicated above, a client device 102 can be connected to or otherwise associated with a beacon device 106 (also referred to herein as a “beacon”). A beacon 106 refers to a wireless transmitter that emits signals that are detectable by nearby client devices 102. A beacon 106 can communicate with other devices via low energy wireless technology (e.g., e.g., Bluetooth® Low Energy (BLE) technology, near field communication (NFC) technology, etc.). In some embodiments, a beacon 106 can be powered by a discrete power source (e.g., a battery, such as a button battery or smaller sized battery). A beacon 106 can transmit signals 108 via a low energy wireless connection established between the beacon 106 and client devices 102 (e.g., that are physically located near the beacon). Such signals 108 are sometimes referred to as advertisements. Beacon signals 108 can include information pertaining to the beacon 106 and/or an environment in which the beacon 106 resides. For example, a beacon signal 108 can include a value of a cryptographic key associated with the beacon 106, as described herein. In some embodiments, a beacon 106 can include one or more sensors 109 configured to monitor an environment of the beacon 106. In such embodiments, the beacon signals 108 may include data collected by the one or more sensors 109. For example, a beacon 106 can include a temperature sensor configured to monitor a temperature of an environment of beacon 106. The beacon signal 108 of such beacon 106 can include temperature data indicating the monitored temperature of the environment. In some instances, size of a beacon signal 108 can be relatively small (e.g., 256 bytes, or sometimes as small as 37 bytes).

In some embodiments, system 100 may include a platform 120. Platform 120 can be configured to manage communications between client devices 102 and beacons 106. As illustrated in FIG. 1, platform 120 can include a device management engine 152, which can be configured to collect and/or organize data associated with beacon devices 106 associated with users of platform 120. In some embodiments, platform 120 can provide users with access to the collected and/or organized data via a beacon tracking application 121. For example, a user of platform 120 can attach a beacon 106 to a real-world object (e.g., a set of keys, a wallet, a bicycle, etc.) for tracking a location of the real-world object using the beacon tracking application 121. Device management engine 152 can receive secure messages including data that indicates a location of the beacon 106 can provide the user with access to the data via the beacon tracking application 121. In another example, a user of platform 120 can place a beacon 106 in an environment for tracking of conditions of the environment. Device management engine 152 can receive messages including sensor data collected by sensors 109 of the beacon 106 and can provide the user with access to the data via the beacon tracking application 121. It should be noted that in some embodiments, messages of beacon 106 may be encoded using an encryption key that is unknown to the platform 120 and/or device management engine 152, but is known to a client device 102 that is accessing the message (e.g., via the beacon tracking application 121). As neither platform 120 nor device management engine 152 have access to the encryption key, platform 120 is unable to access the content of the messages. The client device 102 may decrypt the secure message using the encryption key to access the content of the message, in accordance with embodiments described herein. Further details regarding the encryption of messages of beacon signal 108, beacon tracking application 121, and device management engine 152 are described herein.

In some embodiments, a user of a client device 102 may access data of beacon tracking application 121 via an application instance 122 running via client device 102. An application instance 122 refers to a set of processes for an application that are executing using computing resources (e.g., client device 102) associated with a particular user. Each instance 122 of application 121 can provide the same or similar functionality, but can be isolated from other application instances 122. As illustrated in FIG. 1, client device 102A can access the functionality and/or features of application 121 via application instance 122A and client device 102N can access the functionality and/or features of application 121 via application instance 122N.

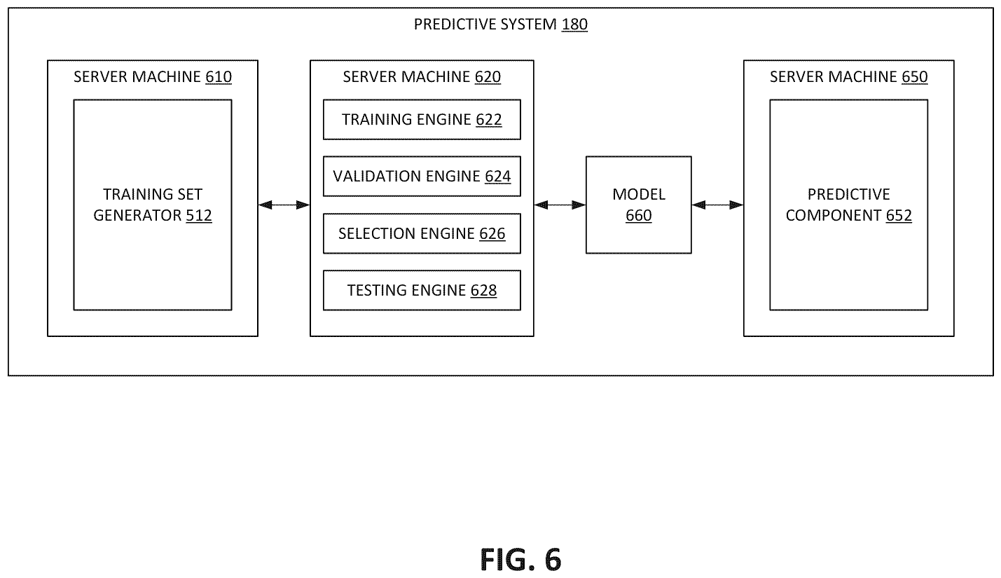

In some embodiments, system 100 can include a predictive system 180. Predictive system 180 implement one or more artificial intelligence (AI) and/or machine learning (ML) techniques to generate or otherwise obtain a cryptographic key (also referred to simply as a “key” herein) that is used for communications between a client device 102 and a beacon 106. In some embodiments, predictive system 180 can generate a private key that is unique to a particular client device 102. In other or similar embodiments, predictive system 180 can generate one or more public keys (e.g., a public key for client device 102, one or more public ephemeral keys, etc.). Further details regarding predictive system 180 are described with respect to FIG. 6.

It should be noted that although FIG. 1 illustrates device management engine 152 as part of platform 120, in additional or alternative embodiments, device management engine 152 can reside on one or more server machines that are remote from platform 120. For example, device management engine 152 can reside at server machine 150. In other or similar embodiments, device management engine 152 can reside on one or more client devices 102. Further, although FIG. 1 illustrates predictive system 180 as remote from platform 120, in additional or alternative embodiments, predictive system 180 can reside on platform 120, server machine(s) 150, client device 102, and/or any other component of system 100. It should be noted that in some other implementations, the functions of platform 120, server machine 150, and/or predictive system(s) 180 can be provided by more or a fewer number of machines. For example, in some implementations, components and/or modules of platform 120, server machine 150, and/or predictive system(s) 180 may be integrated into a single machine, while in other implementations components and/or modules of any of platform 120, server machine 150, and/or predictive system(s) 180 may be integrated into multiple machines. In addition, in some implementations, components and/or modules of server machine 150, and/or predictive system(s) 180 into platform 120.

In general, functions described in implementations as being performed by platform 120, server machine 150, and/or predictive system(s) 180 can also be performed on the client device 102 in other implementations. In addition, the functionality attributed to a particular component can be performed by different or multiple components operating together. Platform 120 can also be accessed as a service provided to other systems or devices through appropriate application programming interfaces, and thus is not limited to use in websites.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

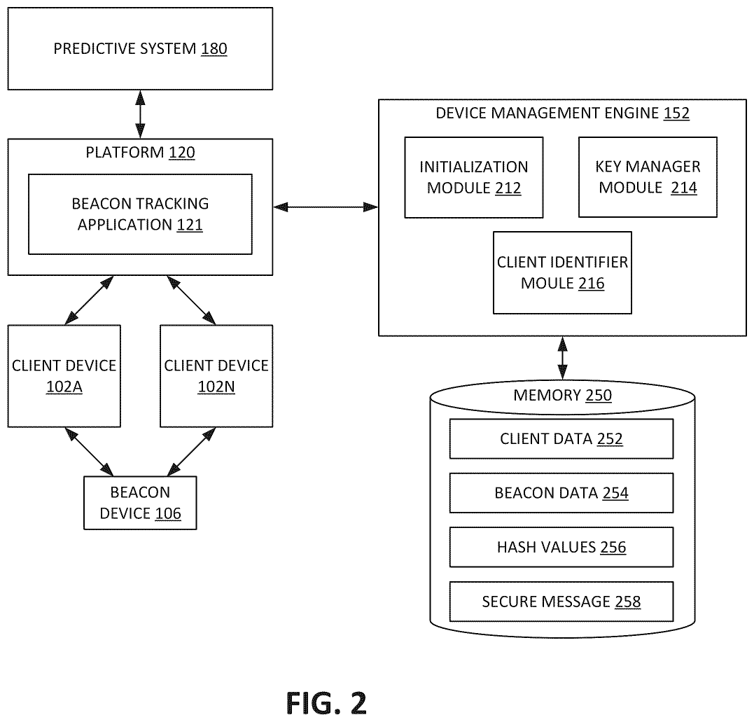

FIG. 2 is a block diagram that includes an example platform 120 and an example device management engine 152, in accordance with implementations of the present disclosure. As described above, device management engine 152 can reside at or can otherwise be connected to platform 120 (e.g., using network 104). In some embodiments, platform 120 and/or device management engine 152 can be connected to memory 250. Memory 250 can correspond to one or more portions of data store 110, in some embodiments. In additional or alternative embodiments, memory 250 can correspond to any memory of, connected to, or accessible by a component of system 100.

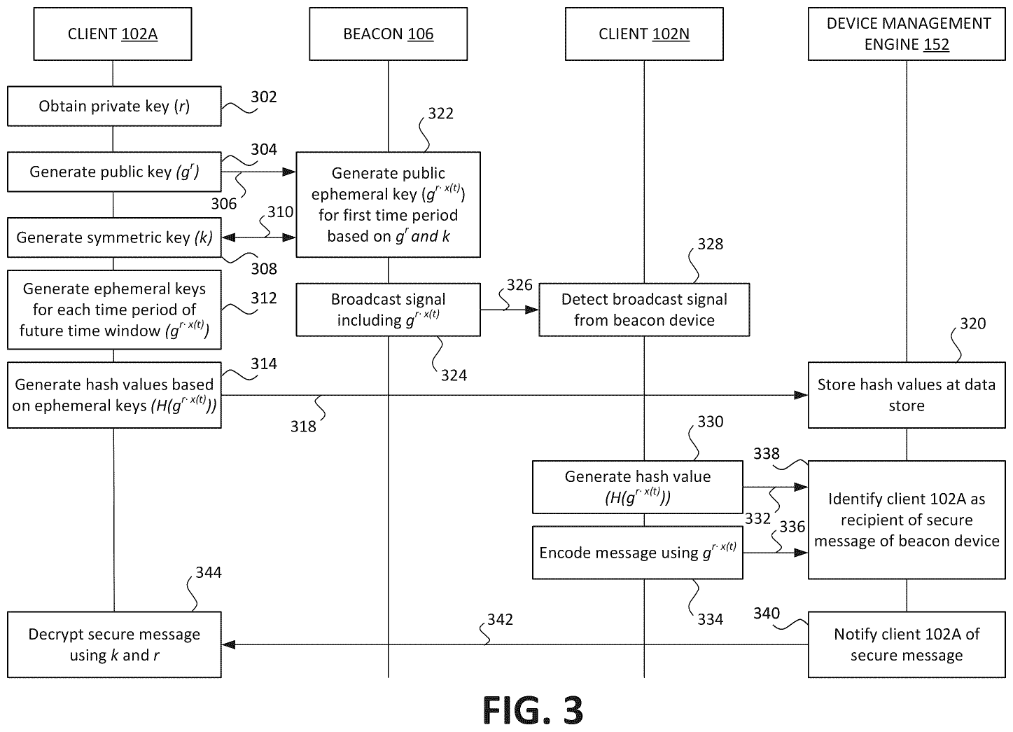

As described above, device management engine 152 can manage communications between client devices 102 and beacons 106. As illustrated in FIG. 2, device management engine 152 can include an initialization module 212, a key manager module 214, and/or a client identifier module 216. Embodiments pertaining to device management engine 152 are described, at least, with respect to FIG. 3 below. It should be noted that although some embodiments of the present disclosure describe the management of communications between a client device 102 and a beacon device 106 by platform 120 and/or device management engine 152, such embodiments can be applied to systems that do not include a platform 120 and/or device management engine 152. For example, such embodiments can be applied to a system that includes one or more client devices 102 and a beacon device 106 (e.g., and does not include a platform 120).

As described above, a beacon device 106 can be used to track a location of a real-world object (e.g., a set of keys, a wallet, a bicycle, etc.) of a user, e.g., via beacon tracking application 121, and/or track a condition of an environment of the beacon 106. An owner device-beacon relationship can be established between the beacon 106 and a client device 102 of the user during an initialization process, described in further detail below. A client device 102 that has established the owner device-beacon relationship with the beacon 106 is referred to as an “owner device” or simply an “owner device.” For purposes of example and explanation only, client device 102A is referred to as owner device client device 102A or simply owner device 102A herein. By establishing the owner device-beacon relationship between the owner device 102A and the beacon 106, messages of or pertaining to signals 108 that are broadcast by beacon 106 are therefore associated with owner device 102A. A client device 102 that has not established the owner device-beacon relationship with beacon 106 can detect signals 108 broadcast by beacon 106, in some embodiments. Such client device 102 may send a message pertaining to the detected signals 108 to owner device 102A and/or platform 120, as described herein. A client device 102 that detects signals 108 of a beacon 106, but has not established an owner device-beacon relationship with the beacon 106 is referred to as a “gateway device” or simply a “gateway.” For purposes of example and explanation only, client device 102N is referred to as gateway client device 102N or simply gateway 102N.

As indicated above, initialization module 212 of device management engine 152 may perform an initialization process to establish an owner device-beacon relationship between owner device 102A and beacon 106. In some embodiments, a user of owner device 102A can initiate the initialization process by engaging with one or more UI elements of beacon tracking application 121 (e.g., accessible to owner device 102A via application instance 122A). For example, a UI of beacon tracking application 121 can include one or more UI elements that enable a user to connect or register a beacon device 106 to an account (e.g., of beacon tracking application 121) associated with the user and/or the owner device 102A. Upon detecting that the user has engaged with a UI element (e.g., via the UI of the owner device 102A), initialization module 212 can initiate the initialization process to establish the owner device-beacon relationship between owner device 102A and beacon 106. In some embodiments, initialization module 212 may update the UI to include instructions for the user to activate the beacon 106 for pairing to the owner device 102A. In an illustrative example, the updated UI can include instructions prompting the user to engage with one or more physical components of the beacon 106 (e.g., press a button, flip a switch, etc.), physically remove a film material disposed between a power element and a power source of the beacon 106, and/or perform other such actions to activate the beacon 106.

Upon activation of the beacon 106, beacon 106 can broadcast one or more signals 108 that are detectable to nearby client devices 102. In some embodiments, such signals 108 can include initialization data (e.g., per a signal protocol of the beacon 106 and/or the platform 120). The initialization data can include an indication that the beacon 106 is ready to pair or connect with a client device 102, in some embodiments. owner device 102A may detect the signal 108 from beacon 106. Upon detecting the signal 108, owner device 102A and/or initialization module 212 may initiate a secure pairing protocol. In some embodiments, the secure pairing protocol may involve the exchange of cryptographic keys (simply referred to herein as “keys”) between owner device 102A and beacon 106, as described with respect to FIG. 3. In some embodiments, a communication channel may be formed between owner device 102A and beacon 106 (e.g., per a networking protocol of client device 102A and/or beacon 106). The communication channel may be supported by a low energy wireless connection (e.g., Bluetooth® Low Energy (BLE) technology, near field communication (NFC) technology, etc.). owner device 102A can transmit messages to beacon 106 via the communication channel, and vice versa. In some embodiments, owner device 102A and/or beacon 106 can transmit keys via the communication channel, in accordance with the secure pairing protocol described herein.

FIG. 3 depicts an example of a scheme for maintaining security of communications in a multi-device environment, in accordance with implementations of the present disclosure. As described above, owner device 102A and/or initialization module 212 may initiate a security pairing protocol, which may involve the exchange of keys between owner device 102A and beacon 106. As illustrated by block 302 of FIG. 3, owner device 102A can obtain a private key (r). The private key (r) can be a cryptographic key that is known only to owner device 102A and is unknown to other devices of system 100. In some embodiments, the private key (r) can be or include a string of random values. owner device 102A can generate the private key (r) based on one or more outputs of a random value generator, in some embodiments. In other or similar embodiments, owner device 102A can obtain the private key (r) based on one or more outputs of predictive system 180, as described with respect to FIG. 6.

At block 304, owner device 102A can generate a public key (g^{r}) based on the private key (r). In some embodiments, owner device 102A can generate the public key (g^{r}) by providing the private key (r) as an input to a one-way cryptographic function that outputs an asymmetric key value. In some embodiments, owner device 102A can determine one or more cryptographic values that are to be used by owner device 102A and beacon 106 to obtain cryptographic keys, per the secure pairing protocol. The cryptographic values can be provided to the one-way cryptographic function to generate the asymmetric key value. In some embodiments, the cryptographic function can be based on or otherwise correspond to an equation, such as g^{a}mod p, where g represents a base value, a represents a private key value, and p represents a prime number value. The cryptographic values to be used by owner device 102A and beacon 106 can include values of g and p, per the equation above. In some embodiments, owner device 102A can obtain the cryptographic values based on the signal 108 detected by owner device 106A. For example, signal 108 can indicate the one or more cryptographic values (e.g., per the signal protocol of beacon 106 and/or platform 120). Upon detecting signal 108, owner device 102A can extract the cryptographic values from signal 108. In other or similar embodiments, owner device 102A and/or beacon 106 can obtain the cryptographic values from platform 120. For example, upon receiving the request to establish the owner device-beacon relationship between owner device 102A and beacon 106, platform 120 may transmit (e.g., via network 104) a message including the cryptographic values to owner device 102A and/or beacon 106. It should be noted that owner device 102A and beacon 106 can obtain the cryptographic values g and/or p according to other techniques, in accordance with embodiments of the present disclosure. It should also be noted that other types of cryptographic functions and/or other techniques can be used to generate the public key (g^{r}) based on the private key (r). For example, the public key (g^{r}) may be generated based on one or more outputs of an AI model of predictive system 180. Upon obtaining the cryptographic values g and p, owner device 102A can provide the private key (r) as input to the cryptographic function and can extract the public key (g^{r}) from one or more outputs of the cryptographic function.

At block 308, owner device 102A and beacon 106 can each generate a symmetric key which is shared between client 102A and beacon 106. In some embodiments, owner device 102A and beacon 106 can generate the symmetric key according to one or more symmetric key generation techniques (e.g., Diffie Hellman key exchange). For example, owner device 102A and beacon 106 may each generate an additional private key (not shown) and generate an additional public key (not shown) based on the additional private key (e.g., based on one or more outputs of the cryptographic function used to generate the public key (g^{r})). The additional private key generated by owner device 102A may be unknown to beacon 106 and the additional private key generated by beacon 106 may be unknown to owner device 102A. However, the public keys generated based on such additional private keys by owner device 102A and beacon 106 can be the same or similar (e.g., per the Diffie Hellman key exchange protocol). In some embodiments, owner device 102A and/or beacon 106 may generate the additional private key and the additional public key based on the cryptographic values shared between owner device 102A and beacon 106 (e.g., g and p) and/or based on additional cryptographic values shared between owner device 102A and beacon 106. The additional public key generated by both owner device 102A and beacon 106 can be used as the symmetric key, as described herein. For purposes of example and explanation only, the symmetric key generated by owner device 102a is referred to herein as symmetric key (k) and the symmetric key generated by beacon 106 is referred to herein as symmetric key (k′)

As described above, owner device 102A and beacon 106 can share messages between the communication channel established between owner device 102A and beacon 106. As illustrated in FIG. 3, owner device 102A can transmit the symmetric key (k) to beacon 106 and beacon 106 can transmit symmetric key (k′) to owner device 102A via the channel (e.g., via transmission 310). Upon receiving symmetric key (k′) from beacon 106, owner device 102A can determine whether a value of symmetric key (k′) matches or otherwise corresponds to a value of symmetric key (k). Upon a determination that the value of symmetric key (k′) matches or corresponds to the value of symmetric key (k), the owner device-beacon relationship is established between owner device 102A and beacon 106. owner device 102A can transmit the public key (g^{r}) generated based on the private key (r), as described above, to beacon 106 via the communication channel (e.g., upon the establishment of the owner device-beacon relationship). As illustrated in FIG. 3, owner device 102A can transmit the public key (g^{r}) according to transmission 306.

Referring back to FIG. 2, memory 250 can include client data 252 and/or beacon data 254. Client data 252 can include data or information pertaining to one or more client devices that are connected to platform 120. For example, client data 252 can include an identifier associated with client device 102A, client device 102N, etc. Beacon data 254 can include data or information pertaining to one or more beacons 106 associated with platform 120 and/or supported by beacon tracking application 121. For example, client data 252 can include an identifier (e.g., a serial number, a networking address, etc.) associated with beacon device 106. In some embodiments, memory 250 can include a data structure (not shown) with one or more entries that indicate a mapping between a client device 102 and one or more beacon devices 106 of which an owner device-beacon relationship is established. Initialization module 212 can detect that the owner device-beacon relationship is established between owner device 102A and beacon 106, as described above, and can update the data structure to include a mapping between an identifier for owner device 102A (e.g., indicated by client data 252) and an identifier for beacon 106 (e.g., indicated by beacon data 254).

It should be noted that although some embodiments of the present disclosure refer to operations of blocks 302, 304, and 308 and/or transmissions 306 and 310 as part of the secure pairing protocol between owner device 102A and beacon 106, the secure pairing protocol can include additional or alternative operations and/or transmissions, in accordance with embodiments of the present disclosure.

In some embodiments, owner device 102A may generate a set of ephemeral keys for each time period of a future time window (e.g., per block 312 of FIG. 3). As will be described in further detail below, beacon 106 can generate one or more ephemeral keys based on the public key (g″) and the symmetric key (k), described above. An ephemeral key refers to a cryptographic key that is generated for use during a particular time period. Such ephemeral key may be used to encrypt and/or decrypt data during the time period. In some instances, the ephemeral key may be destroyed after the expiration of the time period. In such instances, another ephemeral key may be generated for use during a subsequent time period. Beacon 106 may generate new ephemeral keys for respective time periods, according to a key generation protocol of beacon 106 and/or platform 120. For example, beacon 106 may generate a new ephemeral key every hour, according to the key generation protocol. owner device 102A may generate a set of ephemeral keys for each time period of a future time window, during which the beacon 106 will generate a new ephemeral key, in some embodiments. According to the prior example, owner device 102A can generate a set of ephemeral keys for each hour of a 24 hour time period, where each ephemeral key corresponds to an ephemeral key that the beacon 106 will generate within that future time window. In some embodiments, the length or size of the future time window can be established based on the key generation protocol of platform 120. In other or similar embodiments, the length or size of the future time window can be determined based on historical or experimental data collected based on communications between client devices 102 and beacons 106 of system 100.

In some embodiments, owner device 102A may generate the set of ephemeral keys by generating a private ephemeral key (r·x(t)) based on the symmetric key (k), where the value of t represents a respective time period of the future time window and the value of x(t) represents an ephemeral key for the respective time period. In some embodiments, owner device 102A can obtain the value of x(t) by providing the value of the symmetric key (k) as an input to one or more cryptographic functions and extracting the value of x(t) from an output of the one or more cryptographic functions. The one or more cryptographic functions can be the same cryptographic functions as described above or can include additional or alternative cryptographic functions for generating a private ephemeral key. As will be seen later, the value of x(t) can be calculated by both owner device 102A and beacon 106, e.g., as owner device 102A and beacon 106 share symmetric key (k), in accordance with previously described embodiments. In some embodiments, owner device 102A may generate the private ephemeral key (r·x(t)) by providing the value of x(t) and r as an input to the one or more cryptographic functions and extracting the value of the private ephemeral key (r·x(t)) from the one or more outputs. In such embodiments, owner device 102A may generate the private ephemeral key (r·x(t)) for each time period of the future time window based on the outputs of the cryptographic functions, as described above. In other or similar embodiments, owner device 102A may provide the private key (r) and the symmetric key (k) to predictive system 180. Predictive system 180 may generate or otherwise obtain the private ephemeral keys (r·x(t)) for each time period of the future time window based on the values of private key (r) and the symmetric key (k) and can provide the generated private ephemeral keys (r·x(t)) to owner device 102A.

Upon generating the private ephemeral key (r·x(t)) for each time period of the future time window, owner device 102A may generate a set of public ephemeral keys (g^{r·x(t)}) based on each private ephemeral key (r·x(t)). In some embodiments, owner device 102A can generate a public ephemeral key for a respective time period by providing the private ephemeral key (r·x(t)) as input to a one-way cryptographic function that outputs an asymmetric key value and extracting the public ephemeral key (g^{r·x(t)} from one or more outputs of the cryptographic function. In some embodiments, one-way cryptographic function can be the same or a similar function as the cryptographic function used to generate the public key (g^{r}) based on the private key (r). In such embodiments, the base value (g) and/or the prime number value (p) of the cryptographic function can be the same values used to generate the public key (g^{r}). It should be noted that the base value (g), the prime number value (p), and/or other values of the cryptographic function can be different from and/or obtained according to different techniques than the values used to generate the public key (g^{r}), in other or similar embodiments. In some embodiments, owner device 102A can obtain each of the set of public ephemeral keys (g^{r·x(t)}) by providing each of the private ephemeral keys (r·x(t)) as an input to the cryptographic function, as described herein. owner device 102A can obtain the set of public ephemeral keys (g^{r·x(t)}) according to different techniques (e.g., from one or more outputs of an AI model of predictive system 180), in other or similar embodiments.

At block 314, owner device 102A can generate a set of hash values based on the set of public ephemeral keys (g^{r·x(t)}. A hash value refers to string of values of a fixed length that uniquely identifies data. owner device 102A can generate the set of hash values by providing each of the set of public ephemeral keys (g^{r·x(t)}) as an input to a hash function and extracting a hash value (H(g^{r·x(t)})) corresponding to a respective public ephemeral key (g^{r·x(t)})) from one or more outputs of the hash function. The each of the generated set of hash values (H(g^{r·x(t)})) can correspond to a respective public ephemeral key (g^{r·x(t)}, where each of the set of hash values H(g^{r·x(t)}) is a distinct string of values having a common fixed length. In some embodiments, the hash function can include a message digest function (e.g., MD5), a secure hash function (e.g., SHA-1, SHA-2, etc.), or any other type of hash function (e.g., a cyclic redundancy check function, a checksum function, a Rabin fingerprint function, a tabulation hashing function, a universal one-way hash function, a Zobrist hashing function, and so forth).

In some embodiments, owner device 102A can transmit the set of hash values (H(g^{r·x(t)})) to platform 120 (e.g., transmission 318 of FIG. 3). Upon receiving the set of hash values (H(g^{r·x(t)})), key manager module 214 of device management engine 152 can store the set of hash values (H(g^{r·x(t)})) at memory 250 (e.g., as hash values 256), at block 320. In some embodiments, key manager module 214 can update client data 252 and/or an entry of the data structure (not shown) associated with client device 102A to associate client device 102A with the received hash values 256. As explained in further detail below, device management engine 152 may use hash values 256 to identify messages associated with beacon 106 as being directed to client device 102A.

As described above, the set of hash values (H(g^{r·x(t)})) are generated for each time period of a future time window, per a key generation protocol associated with beacon 106 and/or platform 120. At (or prior to) the expiration of the last time period of the future time window, owner device 102A can generate additional set of hash values (H(g^{r·x(t)})) for each time period of a subsequent future time window and provide the additional set of hash values (H (g^{r·x(t)})) to platform 120, in accordance with previously described embodiments. In an illustrative example, owner device 102A can generate the set of hash values (H(g^{r·x(t)})) for each hour of a 24 hour time window, per the key generation protocol. owner device 102A can generate the set of hash values (H(g^{r·x(t)})) at or prior to an initial time period (e.g., hour 0) of the future time window. Accordingly, at or prior to hour 0 of the 24 hour time window, owner device 102A can generate a hash value (H(g^{r·x(t)})) for each of hours 0-23 of the 24 hour time window. At (or prior to) the expiration of hour 23 of the 24 hour time window, owner device 102A can generate an additional set of hash values (H(g^{r·x(t)})) for the next 24 hour time window (e.g., hours 24-48) and can provide the additional set of hash values (H(g^{r·x(t)})) to platform 120, as described above.

Referring back to FIG. 3, beacon 106 can receive the public key (g^{r}) and the symmetric key (k) from owner device 102A (e.g., per transmissions 306 and 310 described above). At block 322, beacon 106 can generate a public ephemeral key (g^{r·x(t)}) for a first time period (t) of the time window based on the received public key (g^{r}) and the symmetric key (k). In some embodiments, beacon 106 can generate the public ephemeral key (g^{r·x(t)}) based on a private ephemeral key (x(t)) for the first time period, which can be generated based on based on the symmetric key (k), in accordance with previously described embodiments. For example, beacon 106 can provide the symmetric key (k) and an indication of the first time period (t) as an input to a cryptographic function. The cryptographic function can be the same or similar to the other cryptographic functions described herein (e.g., used by owner device 102A to generate the private ephemeral key and/or the public ephemeral key). Beacon 106 can extract the private ephemeral key (x(t)) from one or more outputs of the cryptographic function. In some embodiments, beacon 106 can provide the private ephemeral key (x(t)) and the public key (g^{r}) as an input to an additional cryptographic function and extract the public ephemeral key (g^{r·x(t)} from one or more outputs of the additional cryptographic function. In some embodiments, the additional cryptographic function can be the same or similar to the cryptographic function used to generate the private ephemeral key (x(t)). In other or similar embodiments, the additional cryptographic function can be a different cryptographic function that calculates the public ephemeral key (g^{r·x(t)}). In accordance with previously described embodiments, the public ephemeral key (g^{r·x(t)}) generated by the beacon for the first time period can correspond to a public ephemeral key (g^{r·x(t)}) of the set of public ephemeral keys (g^{r·x(t)}) generated by owner device 102A (e.g., and subsequently hashed and sent to device management engine 152).

At block 324, upon generating the public ephemeral key (^{r·x(t)} for the first time period, beacon 106 can broadcast a signal 108 that includes the public ephemeral key (g^{r·x(t)}. Beacon 106 can periodically broadcast the signal 108 according to the signal protocol of beacon 106 and/or platform 120. In an illustrative example, beacon 106 can broadcast the signal 108 once for every second, 10 seconds, thirty seconds, etc. of the first one hour time period. Each signal can include the public ephemeral key (g^{r·x(t)}) generated for that time period. At or prior to expiration of the first time period, beacon 106 can generate an additional public ephemeral key (g^{r·x(t)}) for the second time period, as described above. According to the above illustrative example, beacon 106 can broadcast the signal 108 once for every second, 10 seconds, thirty seconds, etc. of the second one or more time period, where each signal of the second time period includes the public ephemeral key (g^{r·x(t)} generated for that time period.

The signal 108 broadcast by beacon 106 may be detectable by one or more devices (e.g., client devices 102) that are within a range of communication to the beacon 106. The range of communication refers to a maximum range or distance between the beacon 106 and another device where the signal 108 is detectable per the low energy wireless technology that supports the beacon 106. In some instances, beacon 106 may be outside of the communication range from owner device 102A. For example, beacon 106 may be attached to a wallet of a user associated with owner device 102A. The user may have lost the wallet, and therefore the beacon 106 may be physically separated from and/or outside of the communication range from owner device 102A. As described above, beacon 106 may continuously broadcast the signal 108, which may be detectable to devices that are within the communication range of beacon 106. At block 328, gateway 102N may be a client device 102 that is within the communication range of beacon 106, and therefore may detect broadcasted signal 108 (e.g., transmission 326 of FIG. 3).

As described above, gateway 102N may forward a message pertaining to beacon 106 to a client device 102 and/or a platform 120 associated with beacon 106. In some embodiments, upon detecting signal 108, gateway 102N may generate a message indicating a geographic region of which gateway 102N is located. Gateway 102N may determine its geographic region based on readings by one or more location or positioning sensors or trackers of the client device 102N. For example, gateway 102N may determine its location based on a reading from a global positioning system (GPS) tracker or sensor of client device 102N. Gateway 102N may determine its geographic region according to other techniques, in accordance with embodiments of the present disclosure. In some embodiments, the message generated by gateway 102N can include coordinates (e.g., Cartesian coordinates, polar coordinates, etc.) associated with the geographic region of the gateway 102N. As described above, beacon 106 can include one or more sensors 109 that collect data indicating a condition of an environment of beacon 106. In some embodiments, signal 108 broadcast by beacon 106 can include the data collected by the one or more sensors 109. The message generated or otherwise obtained by gateway 102N can include the collected sensor data, in some embodiments.

At block 330, gateway 102N can generate a hash value of the public ephemeral key (g^{r·x(t)}) included in the broadcast signal 108 (e.g., of transmission 326) . Gateway 102N can generate the hash value by providing the public ephemeral key (g^{r·x(t)} as an input to a hash function and extracting the hash value (H(g^{r·x(t)})) from the one or more outputs. The hash function used by gateway 102N can be the same as the hash function used by owner device 102A to generate the set of hash values (H(g^{r·x(t)})), as described above. Gateway 102N can transmit the generated hash value (H(g^{r·x(t)})) to platform 120 (e.g., via transmission 332 of FIG. 3).

At block 334, gateway 102N can encode the message using the public ephemeral key (g^{r·x(t)}. In some embodiments, gateway 102N can encode the message by providing the contents of the message and the public ephemeral key (g^{r·x(t)} as input to an encryption function and extracting the encoded message from one or more outputs of the encryption function. The encryption function can include any type of function configured to generate encoded data based on given data and a given encryption key. Upon encoding the message using the public ephemeral key (g^{r·x(t)}), gateway 102N can transmit the encoded message to platform 120 (e.g., via transmission 336 of FIG. 3), in some embodiments. Gateway 102N may transmit the encoded message to platform 120 with the generated hash value (H(g^{r·x(t)})). In other or similar embodiments, gateway 102N may transmit the encoded message directly to owner device 102A.

Device management engine 152 can receive the encoded message and the generated hash value (H(g^{r·x(t)})) transmitted to platform 120 by gateway 102N, in some embodiments. In some embodiments, device management engine 152 can store (e.g., temporarily) the encoded message at data store 250 as secure message 258. Upon receiving the encoded message and the generated hash value (H(^{r·x(t)})) client identifier module 216 of device management engine 152 may identify a client device 106 that is associated with beacon 106 based on hash values 256 provided to platform 120 by client devices 102 of system 100. In some embodiments, client identifier module 216 may compare the hash value (H(g^{r·x(t)})) received from gateway 102N to hash values 256 received from client devices 102 to determine whether the hash value (H(^{r·x(t)})) is associated with a particular client device 102. Upon determining that the hash value (H(g^{r·x(t)})) matches a hash value 256 of memory 250, client identifier module 216 can identify a client device 102 associated with the matched hash value 256. For example, client identifier module 216 can determine a mapping generated between the matched hash value 256 and an identifier for the client device 102 (e.g., based on client data 252 and/or other data of a data structure of memory 250) and can determine the identifier for the client device 102 based on the determined mapping. In accordance with previously described embodiments and examples, at block 338, client identifier module 216 can identify client device 102A as the recipient of the secure message 258 of beacon device 106.

At block 340, client identifier module 216 (or another component of device management engine 152) can notify owner device 102A of the secure message. In some embodiments, client identifier module 216 can forward the secure message 258 to owner device 102A (e.g., as a transmission 342 via network 104). In other or similar embodiments, client identifier module 216 can transmit a signal to owner device 102A (via transmission 342) indicating that a secure message 258 has been received for owner device 102A. The signal may indicate an address of memory 250 that stores the secure message 258. owner device 102A may access the secure message 258 at indicated address of memory 250, in such embodiments.

At block 344, owner device 102A decrypts the secure message 258 using the symmetric key (k) and the private key (r). In accordance with previously described embodiments, owner device 102A can generate a private ephemeral key (r·x(t)) for the current time period (e.g., the time period during which the notification of the secure message was received). owner device 102A can generate a public ephemeral key (g^{r·x(t)})for the current time period based on the private ephemeral key (r·x(t)). As described with respect to block 334, the secure message 258 was encoded by gateway 102N using the public ephemeral key (g^{r·x(t)}). Accordingly, owner device 102A can access the contents of the secure message 258 using the generated public ephemeral key (g^{r·x(t)}). For example, owner device 102A can provide the secure message 258 and the public ephemeral key (g^{r·x(t)}) as input to a decryption function and extract the decrypted contents of the secure message 258 from one or more outputs of the decryption function.

In some embodiments, owner device 102A may be unable to decrypt the contents of secure message 258 using the public ephemeral key (g^{r·x(t)}) generated for the current time period. In such embodiments, owner device 102A may generate another public ephemeral key (g^{r·x(t)}) for a prior time period and may use the other public ephemeral key (g^{r·x(t)}) to decrypt the contents of the secure message 258. owner device 102A may generate public ephemeral keys (g^{r·x(t)}) for each time period prior to the current time period until a public ephemeral key (g^{r·x(t)}) that decrypts the contents of secure message 258 is obtained. If no public ephemeral key (g^{r·x(t)}) that decrypts the contents of secure message 258 is obtained, beacon tracking application 121 may update the UI of client device 102A to indicate an error of the connection between client device 102A and beacon device 106 and/or prompt the user to reinitialize the connection between client device 102A and beacon device 106 (e.g., per the secure connection protocol).

As described above, the contents of the message 258 can indicate a geographic region of gateway 102N when the broadcast signal 108 was detected and/or sensor data collected by one or more sensors 109 of beacon 106. Upon decryption of the secure message 258, beacon tracking application 121 can update a UI of client device 102A to provide the decrypted content to a user of client device 102A. In an illustrative example, beacon tracking application 121 can update the UI of client device 102A to include one or more map elements that represent the coordinates for the geographic region indicated by the secure message 258. The updated UI can additionally or alternatively include information indicating a distance between client device 102A and beacon 106 (e.g., in view of the coordinates) and/or a set of directions for the user to find the beacon 106. In another illustrative example, beacon tracking application 121 can update the UI of client device 102A to include the sensor data collected by sensors 109 of beacon 106, as described herein.

As indicated above, gateway 102N that detects the signal 108 of beacon 106 may forward the secure message 258 directly to owner device 102A (e.g., without sending the secure message 258 to platform 120). For example, the signal 108 of beacon 106 may indicate an identifier associated with client device 102A (e.g., a network address, etc.). Gateway 102N may generate and/or encrypt the message of beacon 106, as described above, and may forward the encrypted message 258 directly to owner device 102A, in such embodiments. In another example, gateway 102N may have access to a data structure that includes mappings between beacon devices 106 and client devices 102. Upon detecting the signal 108 of beacon 106, gateway 102N may determine that the beacon 106 is associated with owner device 102A based on the mappings of the data structure and can forward the encrypted message 258 based on the determination, in such embodiments.

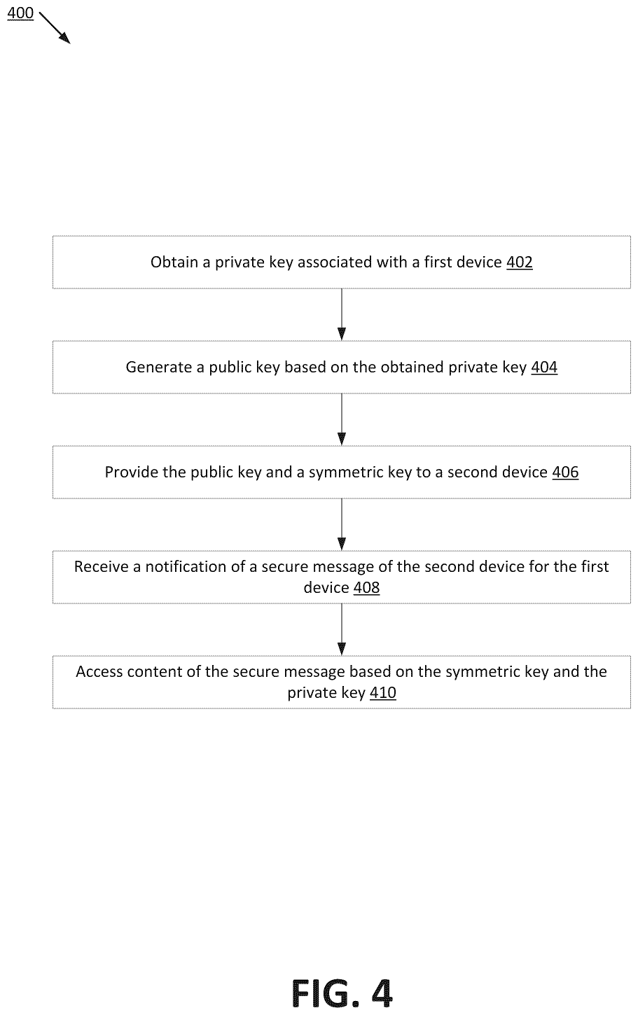

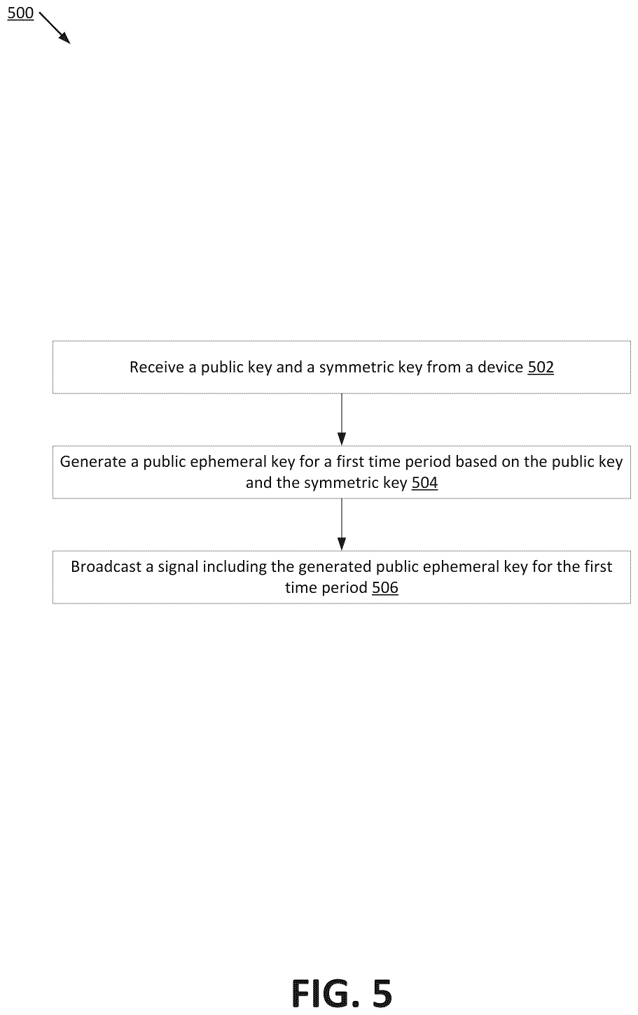

FIGS. 4 and 5 depict flow diagrams of example methods 400 and 500 for maintaining security of communications in a multi-device environment, in accordance with implementations of the present disclosure. Methods 400 and/or and 500 can be performed by processing logic that can include hardware (circuitry, dedicated logic, etc.), software (e.g., instructions run on a processing device), or a combination thereof. In one implementation, some or all of the operations of methods 400 and/or 500 can be performed by one or more components of system 100 of FIG. 1. In some embodiments, method 400 can be performed by a client device 102, as described herein. In additional or alternative embodiments, method 500 can be performed by a beacon device 106, as described herein.

Referring now to FIG. 4, at block 402, processing logic obtains a private key associated with a first device (e.g., owner device 102A). The private key is known to the first device and unknown to other devices (e.g., other client devices 102). Processing logic can obtain the private key by extracting a random value from one or more outputs of a random value generator, in some embodiments. At block 404, processing logic generates a public key based on the obtained private key. At block 406, processing logic provides the public key and a symmetric key to a second device (e.g., beacon 106). In some embodiments, the first device can generate a respective ephemeral key for each time period of a future time window. Each respective ephemeral key is generated based on the private key and the symmetric key. The first device can generate a set of hash values based on each respective ephemeral key and can provide the obtained set of hash values to a computing device of a platform.

At block 408, processing logic receives a notification of a secure message of the second device for the first device. At block 410, processing logic accesses content of the secure message based on the symmetric key and the private key. In some embodiments, processing logic can access the content of the secure message by determining a time period when the notification of the secure message is received, and generating a private ephemeral key for the time period based on the symmetric key and the private key. Processing logic can initiate a decryption operation to decrypt the content of the secure message using the private ephemeral key. The decryption operation can involve providing the secure message and/or the private ephemeral key as an input to a decryption function. In some embodiments, processing logic can generate the public ephemeral key based on the private ephemeral key and can initiate the decryption operation by providing the message and/or the public ephemeral key as input to the decryption function, as described above. Responsive to determining that the decryption operation cannot be completed using the private ephemeral key and/or the public ephemeral key, processing logic can generate an additional private ephemeral key/public ephemeral key for a prior time period to the time period when the notification of the secure message is received. Processing logic can initiate the decryption operation to decrypt the content of the secure message using the additional private ephemeral key/public ephemeral key, as described above. In some embodiments, the contents of the secure message indicates a geographic region of the second device. For example, the contents of the secure message can indicate a set of geographic coordinates of a third device (e.g., gateway 102N) located within the indicated geographic region during a time period when the third device detected a signal emitted by the second device.

Referring now to FIG. 5, at block 502, processing logic receives a public key and a symmetric key from a device (e.g., owner device 102A). The public key is generated based on a private key that is known to the device and unknown to other devices (e.g., client devices 102, beacons 106, etc.). At block 504, processing logic generates a public ephemeral key for a first time period based on the public key and the symmetric key. Processing logic can generate the public ephemeral key for the first time period by providing the public key, the symmetric key, and an indication of the first time period (e.g., a timestamp, etc.) as an input to a cryptographic function and extracting the public ephemeral key from the obtained one or more outputs of the cryptographic function. The cryptographic function can be an asymmetric key generation function (e.g., a Diffie Hellman key exchange function). At block 506, processing logic broadcasts a signal including the generated public ephemeral key for the first time period. Upon detecting that the first time period has expired, processing logic generates an updated public ephemeral key for a second time period based on the public key and the symmetric key and broadcasts an additional signal comprising the updated public ephemeral key.

FIG. 6 illustrates an example predictive system 180, in accordance with implementations of the present disclosure. In some embodiments, predictive system 180 can be configured to train one or more AI models 660 associated with device management engine 152. For example, predictive system 180 can be configured to train one or more cryptography models 660 to generate cryptographic keys, as described above.

As illustrated in FIG. 5, predictive system 180 can include a training set generator 612 (e.g., residing at server machine 610), a training engine 622, a validation engine 624, a selection engine 626, and/or a testing engine 628 (e.g., each residing at server machine 620), and/or a predictive component 652 (e.g., residing at server machine 650). In accordance with embodiments described herein, predictive component 652 can be a component of or otherwise accessible to platform 120 and/or client devices 102 of system 100. Training set generator 612 may be capable of generating training data (e.g., a set of training inputs and a set of target outputs) to train model 660.

As mentioned above, training set generator 612 can generate training data for training model 660. Training set generator 612 obtain training data for training model 660 and can organize or otherwise group the training data for training model 660 (e.g., according to the purpose of the model). In an illustrative example, training data can include a data set of existing encryption keys and an indication of their corresponding security attributes (e.g., degree of randomness of the encryption keys, a function used to generate the encryption keys, a security score or rating associated with the encryption keys, etc.). In some embodiments, training set generator 612 can organize the training data into a set of training inputs (e.g., indicating the security attributes) and a set of target outputs (e.g., including the existing encryption keys) and can generate an input/output mapping between each respective training input and each corresponding target output. It should be noted that training set generator 612 can generate any type of training data sufficient for training an AI model to predict encryption keys.

Training engine 622 can train AI model 660 using the training data (e.g., training set T) from training set generator 612. The AI model 660 can refer to the model artifact that is created by the training engine 622 using the training data that includes training inputs and/or corresponding target outputs (correct answers for respective training inputs). The training engine 622 can find patterns in the training data that map the training input to the target output (the answer to be predicted), and provide the AI model 660 that captures these patterns. The AI model 660 can be composed of, e.g., a single level of linear or non-linear operations (e.g., a support vector machine (SVM or may be a deep network, i.e., AI model that is composed of multiple levels of non-linear operations). An example of a deep network is a neural network with one or more hidden layers, and such an AI model may be trained by, for example, adjusting weights of a neural network in accordance with a backpropagation learning algorithm or the like. In one aspect, the training set is obtained by training set generator 612 hosted by server machine 610.

Validation engine 624 may be capable of validating a trained AI model 660 using a corresponding set of features of a validation set from training set generator 612. The validation engine 624 may determine an accuracy of each of the trained AI models 660 based on the corresponding sets of features of the validation set. The validation engine 624 may discard a trained AI model 660 that has an accuracy that does not meet a threshold accuracy. In some embodiments, the selection engine 626 may be capable of selecting a trained AI model 660 that has an accuracy that meets a threshold accuracy. In some embodiments, the selection engine 626 may be capable of selecting the trained AI model 660 that has the highest accuracy of the trained AI models 660.

The testing engine 528 may be capable of testing a trained AI model 660 using a corresponding set of features of a testing set from training set generator 612. For example, a first trained AI model 660 that was trained using a first set of features of the training set may be tested using the first set of features of the testing set. The testing engine 628 may determine a trained AI model 660 that has the highest accuracy of all of the trained AI models based on the testing sets.

Predictive component 652 of server machine 650 may be configured to feed data as input to model 660 and obtain one or more outputs. As described above, a predictive component 652 residing at server machine 650 can be included at or otherwise accessible to device management engine 152. Predictive component 652 can provide data as input to model 256 and obtain one or more outputs. In some embodiments, the input data can include an indication of a security score or rating sought for and/or characteristics of an encryption key to be used according to embodiments of the present disclosure. The one or more outputs can include a cryptographic key and a level of confidence that the cryptographic key is associated with the indicated security score or rating and/or corresponds to the given characteristics of the encryption key.

In some embodiments, one or more portions of model 660 can reside at a client device 102 (e.g., owner device 102A). In such embodiments, owner device 102A may obtain the private key based on one or more outputs of model 660, as described above. The portion of model 660 residing at a client device 102 may be discrete and/or remote form other portions of the model 660 residing at other client devices 102 and/or a memory of predictive system 180. In such embodiments, data that is provided as an input and/or obtained as an output of model 660 may not be provided to predictive system 180 and/or other client devices 102. Accordingly, private keys generated for a respective client device 102 may remain at the client device 102 and therefore are not accessible to any other component of system 100.

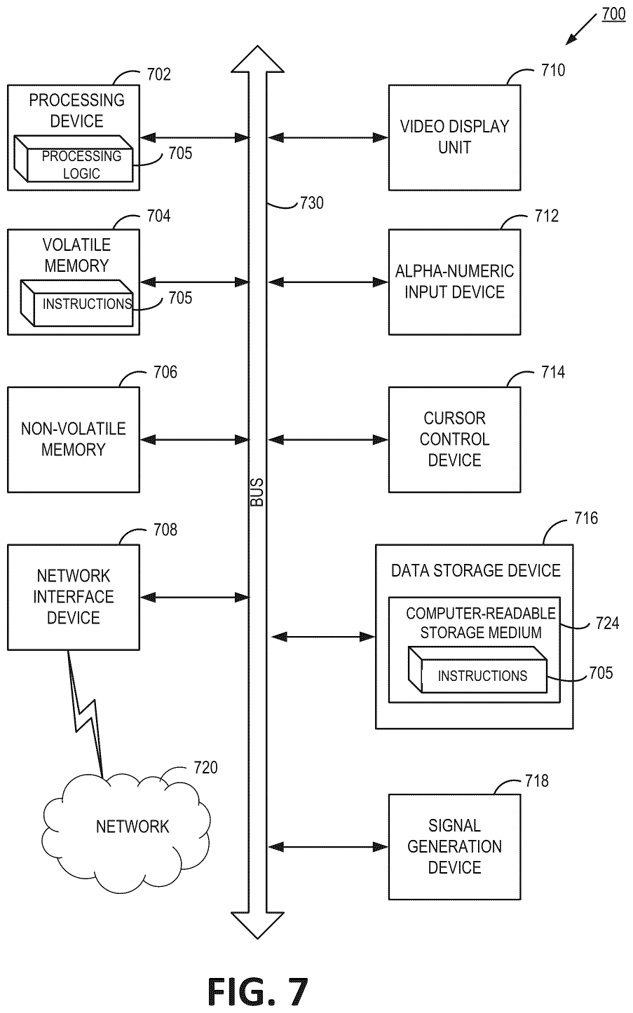

FIG. 7 is a block diagram illustrating an exemplary computer system 700, in accordance with implementations of the present disclosure. The computer system 700 can correspond to platform 120 and/or client devices 102A-N, described with respect to FIG. 1. Computer system 700 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 716, which communicate with each other via a bus 730.

Processor (processing device) 702 represents one or more general-purpose processing devices such as a microprocessor, central processing unit, or the like. More particularly, the processor 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 can also be one or more special-purpose processing devices such as an application specific integrated circuit (ASIC), a field programmable gate array (FPGA), a digital signal processor (DSP), network processor, or the like. The processor 702 is configured to execute instructions 705 for performing the operations discussed herein.

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 718 (e.g., a speaker).

The data storage device 716 can include a non-transitory machine-readable storage medium 724 (also computer-readable storage medium) on which is stored one or more sets of instructions 705 embodying any one or more of the methodologies or functions described herein. The instructions can also reside, completely or at least partially, within the main memory 704 and/or within the processor 702 during execution thereof by the computer system 700, the main memory 704 and the processor 702 also constituting machine-readable storage media. The instructions can further be transmitted or received over a network 720 via the network interface device 708.

In one implementation, the instructions 705 include instructions for providing fine-grained version histories of electronic documents at a platform. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
obtaining, by a first device, a private key associated with the first device, wherein the private key is known to the first device and unknown to other devices;
generating, by the first device, a public key based on the obtained private key;
providing, by the first device, the public key and a symmetric key to a second device;
generating, by the first device, a respective ephemeral key for each time period of a future time window, wherein each respective ephemeral key is generated based on the private key and the symmetric key;
obtaining, by the first device, a set of hash values based on each respective ephemeral key; providing, by the first device, the obtained set of hash values to a computing device of a platform;
receiving, by the first device, a notification of a secure message of the second device for the first device, wherein the secure message is encoded based on a hash value of the set of hash values corresponding to a current time period of the future time window; and
accessing, by the first device, content of the secure message based on the symmetric key and the private key.

2. The method of claim 1, wherein accessing the content of the secure message based on the symmetric key and the private key comprises:
determining a time period when the notification of the secure message is received;
generating a private ephemeral key for the time period based on the symmetric key and the private key; and
initiating a decryption operation to decrypt the content of the secure message using the private ephemeral key.

3. The method of claim 2, further comprising:
responsive to determining that the decryption operation cannot be completed using the private ephemeral key, generating an additional private ephemeral key for a prior time period to the time period when the notification of the secure message is received; and
initiating the decryption operation to decrypt the content of the secure message using the additional private ephemeral key.

4. The method of claim 1, wherein the first device is a client device and the second device is a beacon device.

5. The method of claim 1, wherein the content of the secure message indicates a geographic region of the second device.

6. The method of claim 5, wherein the content of the secure message indicates a set of geographic coordinates of a third device located within the indicated geographic region during a time period when the third device detected a signal emitted by the second device.

7. The method of claim 6, wherein the notification of the secure message is received from a computing device of a platform, the computing device comprising at least one of a server machine of the platform or the third device.

8. The method of claim 1, wherein obtaining the private key comprises:
extracting a random value from one or more outputs of a random value generator.

9. A system comprising:
a memory; and
a set of one or more processing devices coupled to the memory, wherein the set of one or more processing devices is to perform operations comprising:
receiving a public key and a symmetric key from a device, wherein the public key is generated based on a private key that is known to the device and unknown to other devices;
generating a public ephemeral key for a first time period based on the public key and the symmetric key; and
broadcasting a signal comprising the generated public ephemeral key for the first time period.

10. The system of claim 9, wherein the operations further comprise:
upon detecting that the first time period has expired, generating an updated public ephemeral key for a second time period based on the public key and the symmetric key; and
broadcasting an additional signal comprising the updated public ephemeral key.

11. The system of claim 10, wherein generating the public ephemeral key for the first time period comprises:
providing the public key, the symmetric key, and an indication of the first time period as an input to a cryptographic function;
obtaining one or more outputs of the cryptographic function; and
extracting the public ephemeral key from the obtained one or more outputs of the cryptographic function.

12. The system of claim 11, wherein the cryptographic function is an asymmetric key generation function.

13. The system of claim 9, wherein the system is comprised in a beacon device, and wherein the device is a client device associated with a user of a platform.

14. The system of claim 9, further comprising:
one or more sensors configured to collect data pertaining to an environment of the system,
and wherein the broadcast signal further comprises the data collected by the one or more sensors during the first time period.

15. A non-transitory computer readable storage medium comprising instructions for a server that, when executed by a set of one or more processing devices, cause the set of one or more processing devices to perform operations comprising:
obtaining, by a first device, a private key associated with the first device, wherein the private key is known to the first device and unknown to other devices;
generating, by the first device, a public key based on the obtained private key;
providing, by the first device, the public key and a symmetric key to a second device;
generating, by the first device, a respective ephemeral key for each time period of a future time window, wherein each respective ephemeral key is generated based on the private key and the symmetric key;
obtaining, by the first device, a set of hash values based on each respective ephemeral key;
providing, by the first device, the obtained set of hash values to a computing device of a platform;
receiving, by the first device, a notification of a secure message of the second device for the first device, wherein the secure message is encoded based on a hash value of the set of hash values corresponding to a current time period of the future time window; and
accessing, by the first device, content of the secure message based on the symmetric key and the private key.

16. The non-transitory computer readable storage medium of claim 15 wherein accessing the content of the secure message based on the symmetric key and the private key comprises:
determining a time period when the notification of the secure message is received;
generating a private ephemeral key for the time period based on the symmetric key and the private key; and
initiating a decryption operation to decrypt the content of the secure message using the private ephemeral key.

17. The non-transitory computer readable storage medium of claim 16, wherein the operations further comprise:
responsive to determining that the decryption operation cannot be completed using the private ephemeral key, generating an additional private ephemeral key for a prior time period to the time period when the notification of the secure message is received; and
initiating the decryption operation to decrypt the content of the secure message using the additional private ephemeral key.

18. The non-transitory computer readable storage medium of claim 15, wherein the first device is a client device and the second device is a beacon device.

19. The non-transitory computer readable storage medium of claim 15, wherein the content of the secure message indicates a geographic region of the second device.

20. The non-transitory computer readable storage medium of claim 19, wherein the content of the secure message indicate a set of geographic coordinates of a third device located within the indicated geographic region during a time period when the third device detected a signal emitted by the second device.
